(19) United States
(12) Patent Application Publication
(10) Pub. No.: US 2023/0067492 A1
(43) Pub. Date: Mar. 2, 2023

(54) SYSTEMS, APPARATUS AND METHODS FOR DYNAMIC NETWORK RECONFIGURATION IN THE PRESENCE OF NARROWBAND INTERFERERS

(71) Applicant: IDAC HOLDINGS, INC., Wilmington, DE (US)

(72) Inventors: Sudhir Pattar, Mount Laurel, NJ (US); Philip Pietraski, Jericho, NY (US); Alpaslan Demir, East Meadow, NY (US); Joseph Murray, Schwenksville, PA (US); Muhammad Fazili, Audubon, PA (US); Joe Huang, Montville, NJ (US); Tariq Elkourdi, New York, NY (US); Patrick Cabrol, Bayshore, NY (US); Paul Russell, Lawrence, NJ (US)

(73) Assignee: IDAC HOLDINGS, INC., Wilmington, DE (US)

(21) Appl. No.: 17/895,678

(22) Filed: Aug. 25, 2022

Related U.S. Application Data
(60) Provisional application No. 63/330,600, filed on Apr. 13, 2022.
(60) Provisional application No. 63/238,131, filed on Aug. 28, 2021.

(51) Int. Cl. H04W 52/24; H04W 52/36

(52) U.S. Cl. CPC H04W 52/243; H04W 52/367

(57) ABSTRACT

Embodiments disclosed and described herein provide systems, apparatus and methods by which advanced networks including 5G capable networks and devices can operate to meet standards, while coexisting with non-telecommunication devices that propagate energy at frequencies within bands used by the 5G capable networks and devices. In particular, systems, apparatus and methods disclosed herein mitigate risk of the networks interfering with the propagated energy while maintaining operation of the networks and protecting the networks and devices from the energy.

### CROSS-REFERENCE TO RELATED APPLICATIONS

This application claims the benefit of U.S. Provisional Application No. 63/238,131 filed Aug. 28, 2021, and U.S. Provisional Application No. 63/330,600 filed Apr. 13, 2022 the contents of both of which are incorporated herein by reference.

### BACKGROUND

Advanced network standards, including 5G New Radio (NR) standards do not typically specify practical network embodiments that can operate in highly congested and contested spectral environments in which transceivers are vulnerable to jamming and in which non-telecommunications equipment such as radar transceivers propagate energy in bands used by advanced networks. Yet, this is the environment in which such advanced networks are deployed. Systems apparatus and methods are needed by which devices and systems implementing advanced networking technologies such as 5G technologies can operate optimally while coexisting with devices and systems that propagate energy in the same bands used by the networks, without the networks interfering with the propagated energy, and vice versa.

### SUMMARY

Embodiments disclosed and described herein provide systems apparatus and methods by which devices and systems implementing advanced networking technologies such as 5G can operate within an advanced network, while coexisting with non-telecommunications devices and systems that propagate energy in bands used by the 5G capable systems and devices. In particular systems, apparatus and methods disclosed herein mitigate the risk of 5G networks and devices interfering with the energy propagated by the non-telecommunications devices.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 10 is a system diagram illustrating an example radio access network (RAN) and an example core network (CN) that may be used within the communications system illustrated in FIG. 1A according to an embodiment;

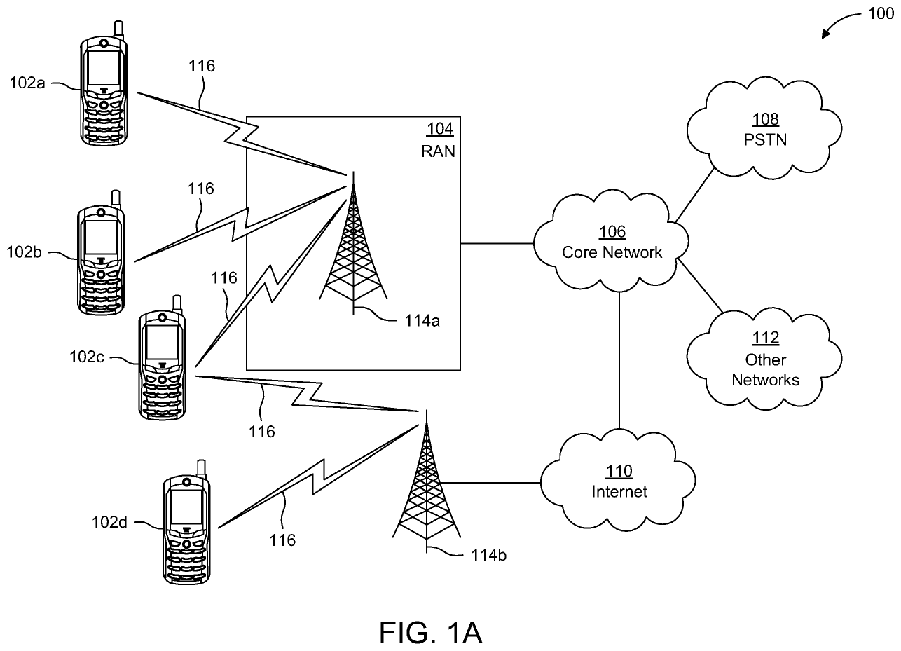

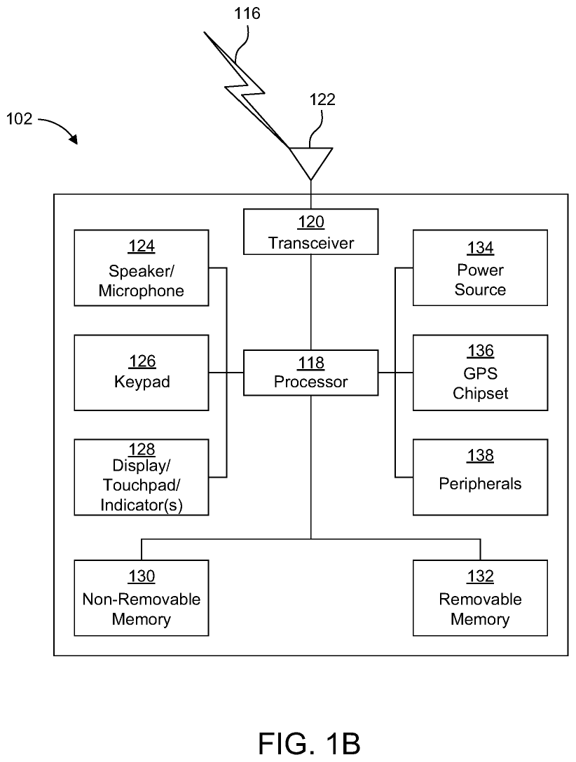

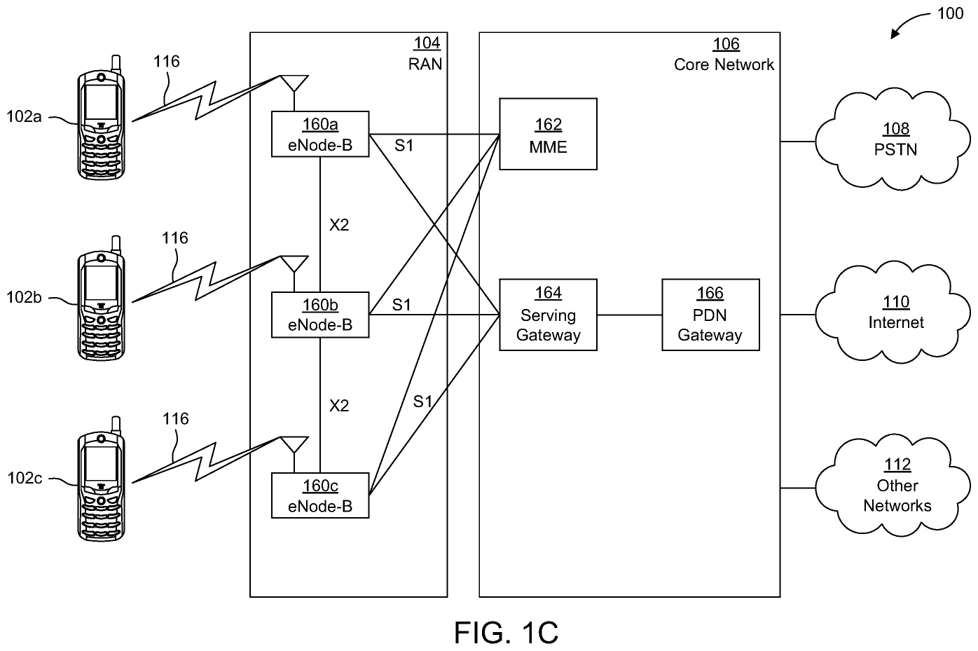

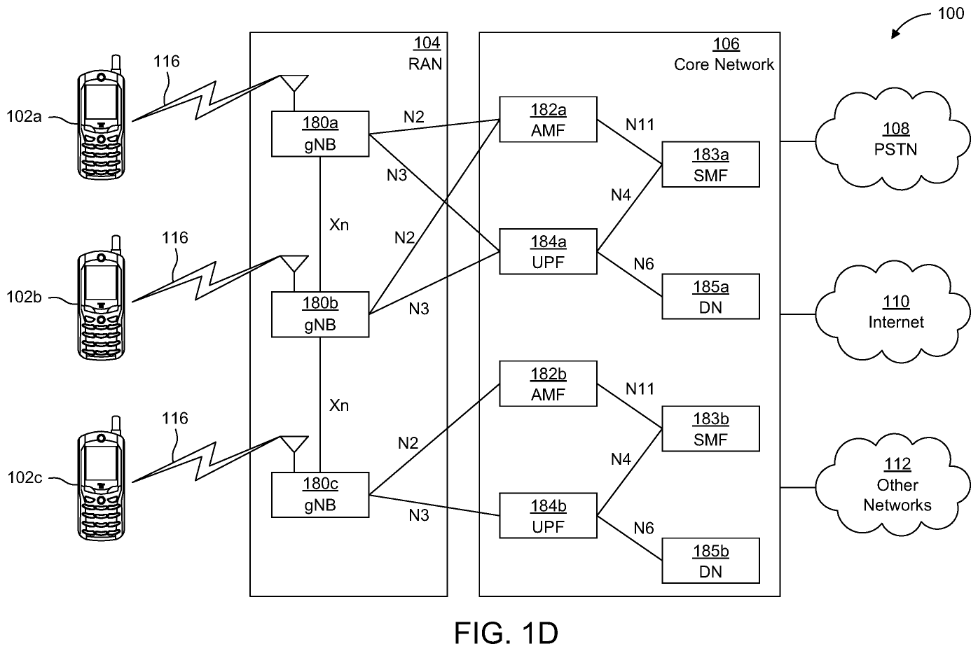

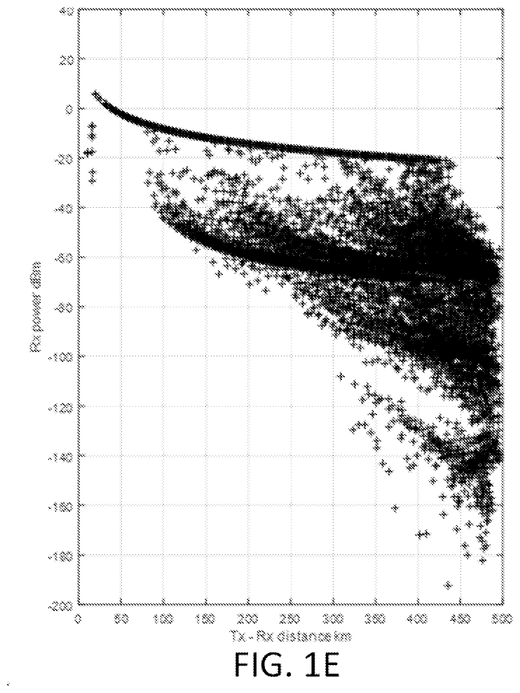

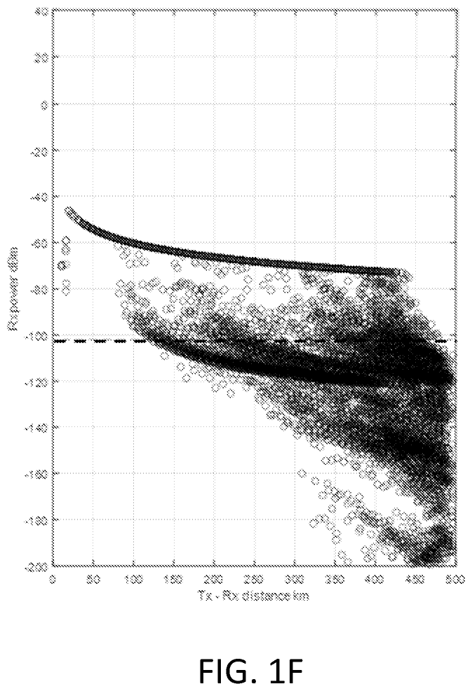

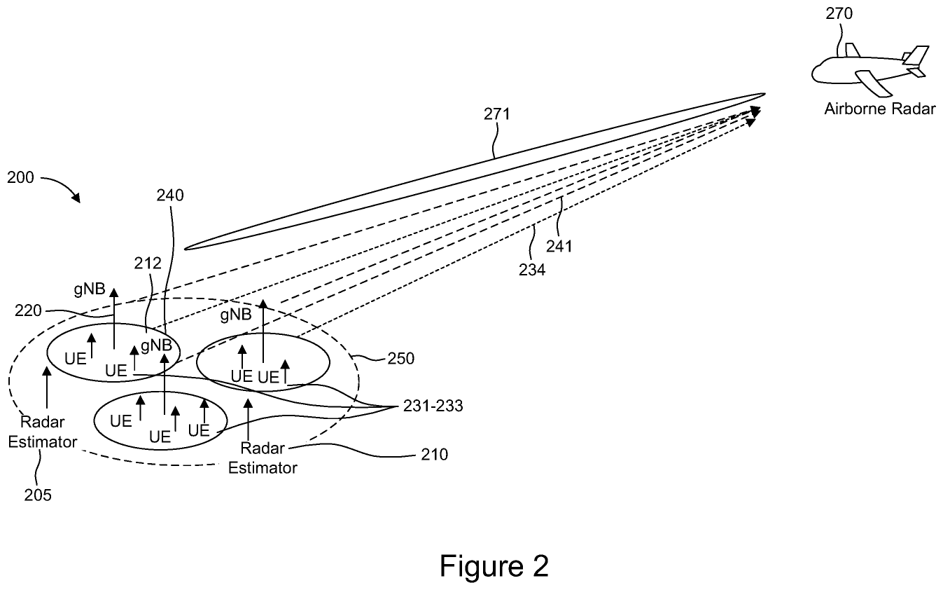

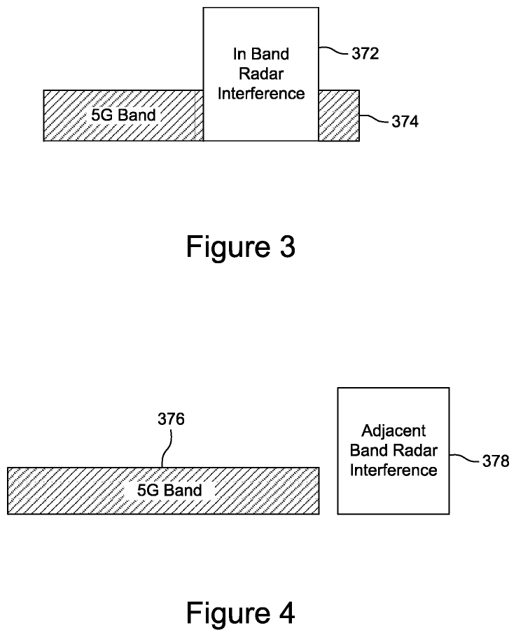

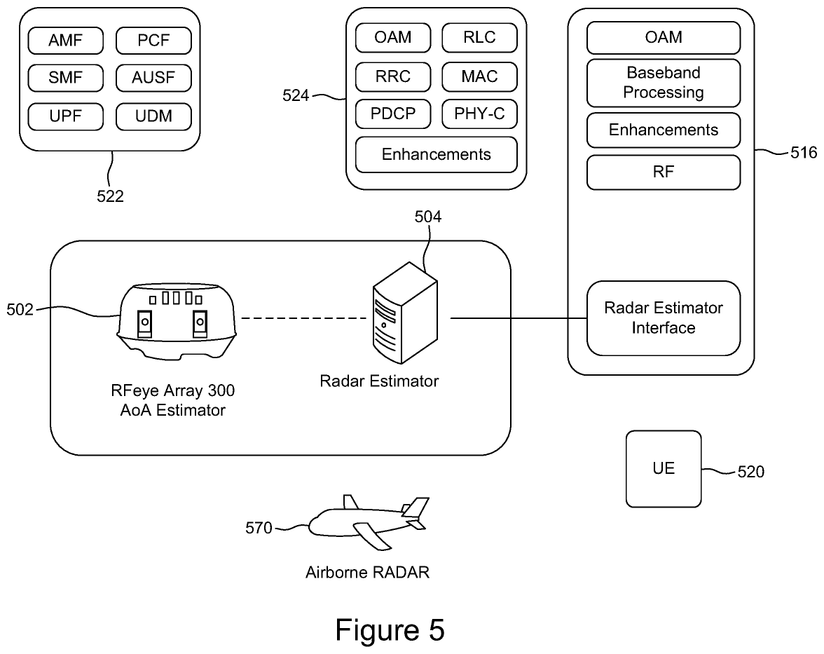

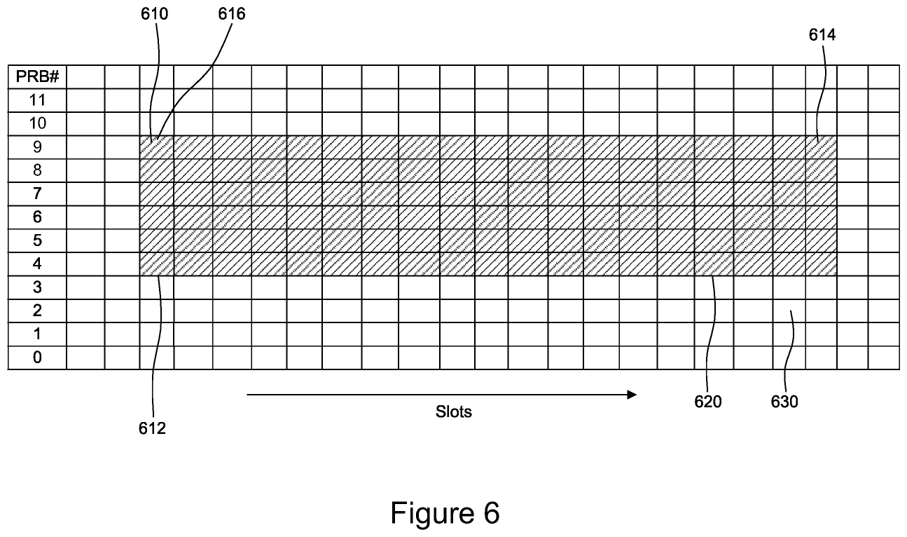

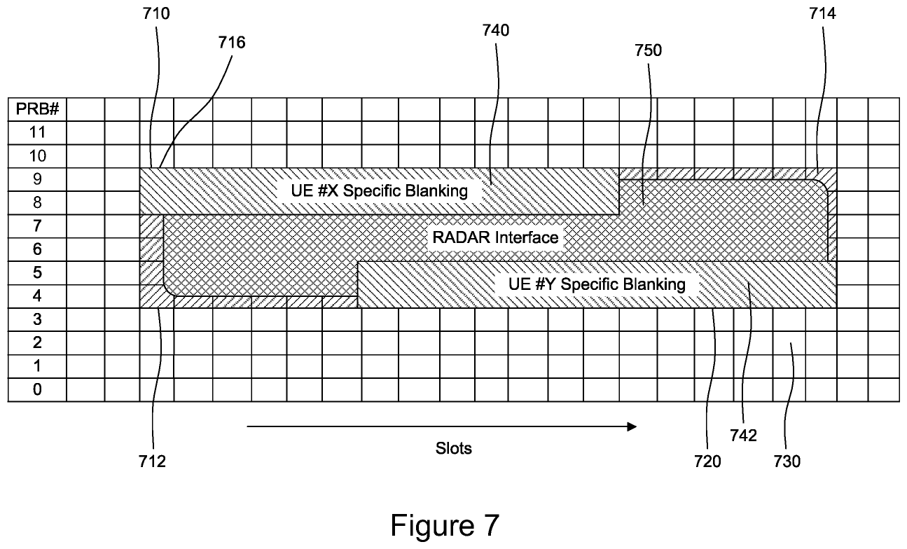

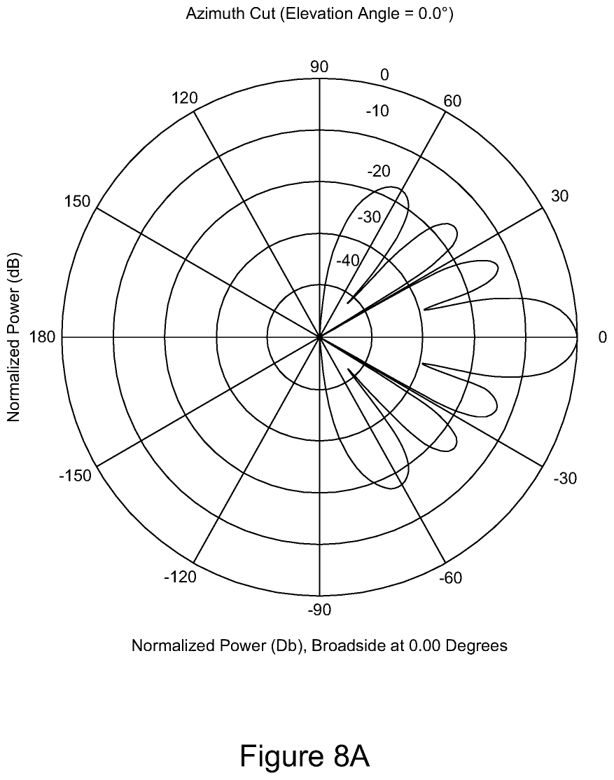

FIG. 1D is a system diagram illustrating a further example RAN and a further example CN that may be used within the communications system illustrated in FIG. 1A according to an embodiment;

FIG. 1E is a graph of the interference levels from a radar on a 5G system;

FIG. 1F is a graph of the interference levels from a 5G system on a radar;

FIG. 2 is a high level pictorial diagram of a system for mitigating risk of harmful interference in the presence of an example radar interferer, including a cooperative arrangement of radar estimator devices according to embodiments;

FIG. 3 is a block diagram showing in band radar interference according to embodiments;

FIG. 4 is a block diagram showing adjacent band radar interference according to embodiments; according to embodiments;

FIG. 5 is a block diagram showing an arrangement of components configured to cooperate to implement dynamic network reconfiguration actions according to embodiments;

FIG. 6 illustrates a technique for mitigating interference in a physical resource block allocation method according to embodiments;

FIG. 7 illustrates a technique for mitigating interference in a physical resource block allocation method according to embodiments;

FIG. 8A illustrates a technique for mitigating interference in a null control method according to embodiments;

FIG. 8B illustrates a technique for mitigating interference in a null control method according to embodiments;

FIG. 8C illustrates a technique for mitigating interference in a null control method according to embodiments;

FIG. 9 illustrates a technique for mitigating interference in a power control method according to embodiments;

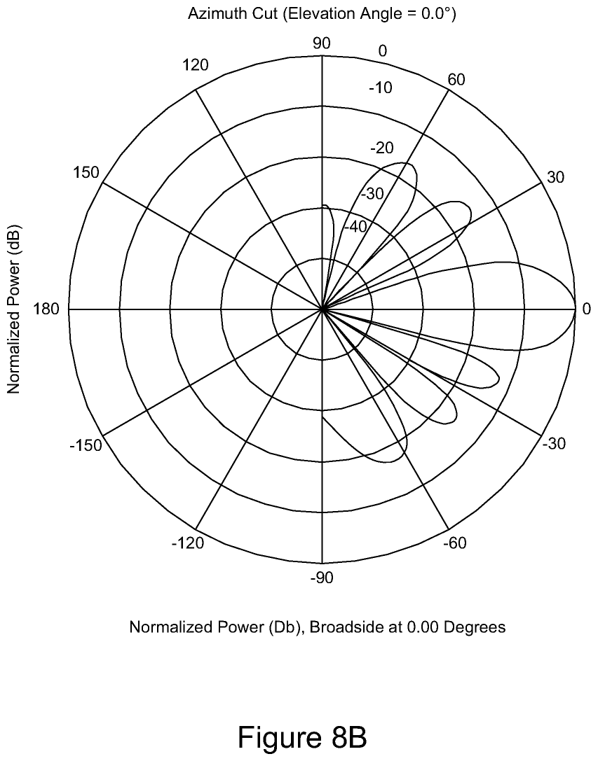

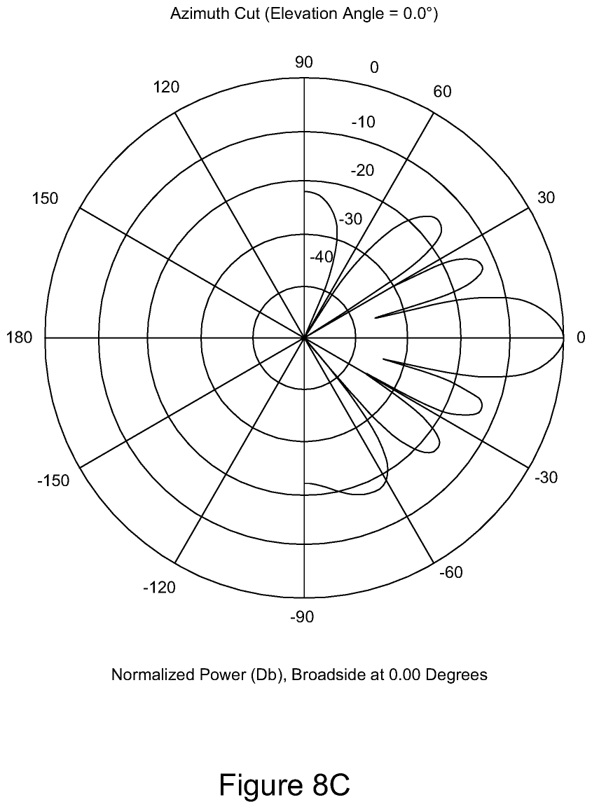

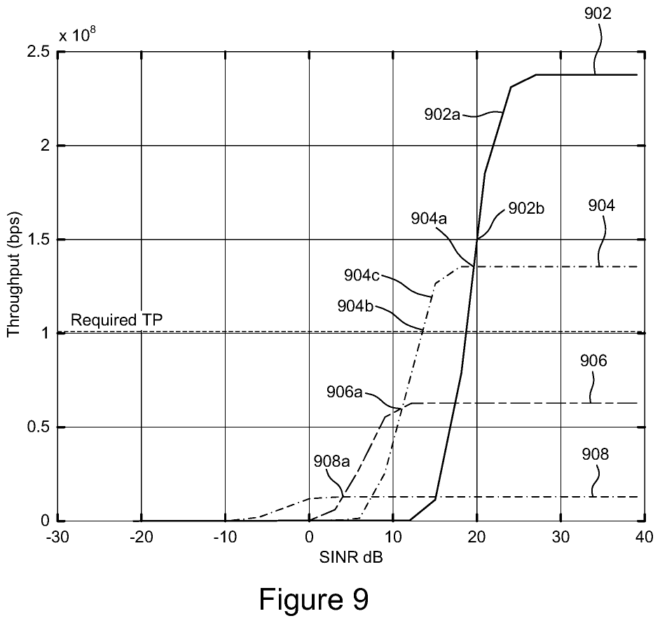

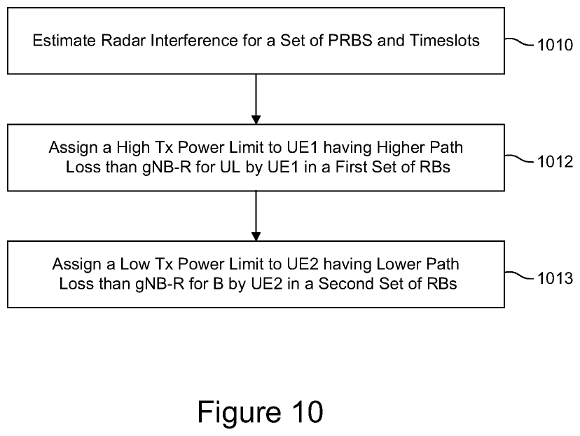

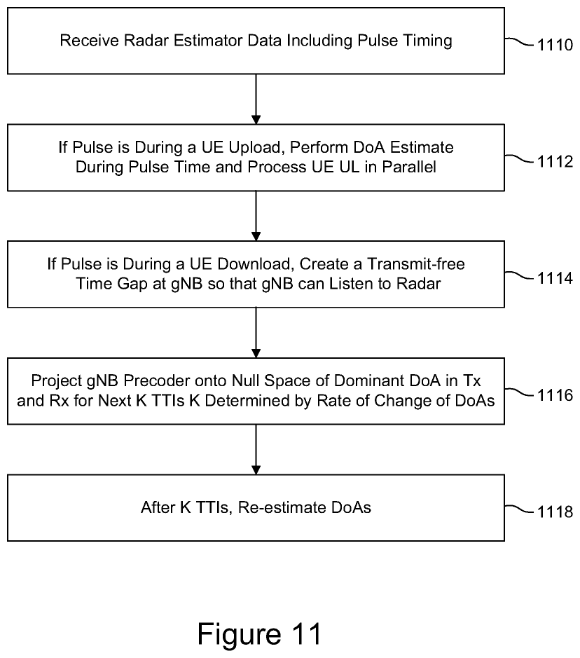

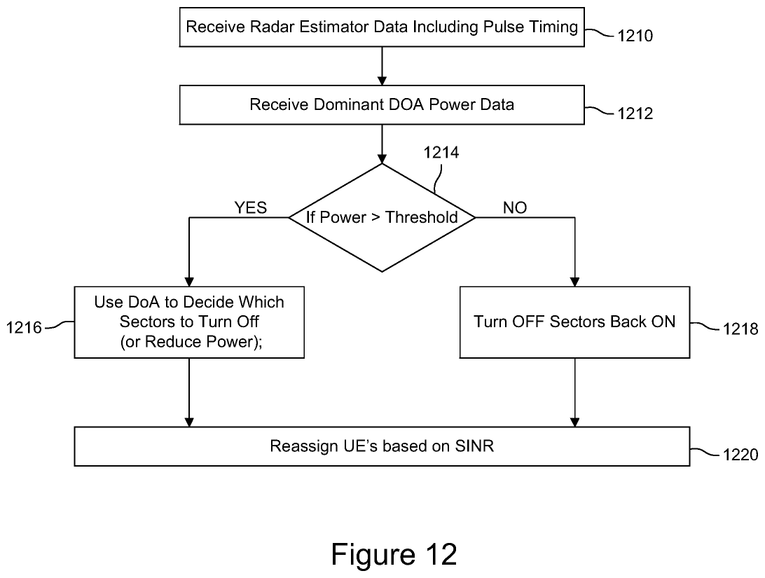

FIG. 10 is a flow diagram of an exemplary process for mitigating the effect of UE transmission on radar reception.

FIG. 11 is a flow diagram of an exemplary process for mitigating the effects of gNB transmissions on radar and radar transmissions on gNB. It does not mitigate the effect of UE transmission on radar.

FIG. 12 is a flow diagram of an exemplary process for mitigating the effect of both gNB and UE transmissions on radar.

### DETAILED DESCRIPTION

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 10 is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In the following description the abbreviations shown below are used.

MCS: Modulation and Coding Scheme

AMC: Adaptive Modulation and Coding

LBT: Listen Before Talk

CSMA: Carrier Sense Multiple Access

RADAR: Radio Detection and Ranging (radar)

NTIA: National Telecommunications and Information Administration

INR: Interference to Noise Ratio

SNR: Signal to Noise Ratio

PRB: Physical Resource Block

PSD: Power Spectral Density

DoA: Direction of Arrival

AoA: Angle of Arrival

ToA: Time of Arrival

LPI: Low Probability of Interception

LPD: Low Probability of Detection

The next generation networks disclosed and described above, e.g., 5G new radio (NR) capable networks, devices and implementing technologies are capable of faster communications than earlier generation networks, both in terms of data throughput and latency. The next generation capabilities find a wide range of practical applications including vehicle-to-vehicle and vehicle-to-infrastructure applications, smart military bases, robotic surgeries, and other real time sensing applications relying on very large numbers of sensors and/or other highly capable devices. Some of these applications call for more resilience and less susceptibility to attack than previous networks such as the those implementing 4G network technologies, could accommodate. For example, practical applications for advanced networks such as 5G include defense and private network applications. However, like earlier generations, advanced network implementations typically presume communication will take place within licensed and dedicated portions of the RF spectrum where there are few challenges to full use of the spectrum.

In typical network implementations in which many devices share access to unlicensed bands, the devices are configured to operate in accordance with medium access protocols, e.g., Listen Before Talk (LBT) and Carrier Sense Multiple Access (CSMA), to share the medium.

These protocols served their purpose in early generation networks. However, they have drawbacks in networks implementing wideband 5G technologies, in that such networks achieve spectrum efficiency and throughput by spreading out communication portions across time and frequency domains. When wideband networks operated in the presence of a narrowband interferer operate within the network bandwidth, there can be conflicts and interference in the narrow band frequencies. 5G standards specify many ways to achieve spectrum efficiency and increased throughput. The standards do not address, however, particular problems that arise in practical implementations, e.g., when the wideband technologies are implemented in highly congested and contested spectral environments in which transceivers are vulnerable to jamming.

Systems apparatus and methods are needed by which 5G capable devices operating in 5G capable network implementations can coexist with other devices and systems that must operate within the same bands. In particular, systems, apparatus and methods are needed to mitigate interference caused by 5G capable telecommunications nodes and devices to non-telecommunications systems and devices and vice versa.

Some 5G network implementations include advanced technologies and capabilities such as beamforming that can be leveraged to limit the RF energy transmitted to and from a narrow band interferer, thereby mitigating the risk of interference. However, these approaches have disadvantages in that they rely on knowledge of the Direction of Arrival (DoA) of an interfering signal. Further, advanced signal processing techniques for interference cancellation depend on knowledge of the interferer's waveforms for interference cancellation. Knowledge and use of waveforms are restricted, for example, when the interferer is a classified government asset.

To meet these and other challenges, systems, apparatus and methods are disclosed herein that reduce interference, or mitigate risk of interference with non-telecommunication devices and systems including but not limited to radar. Methods include adaptive power control techniques, dynamic resource allocation, beamforming to create nulls in directions of interferers, physical resource block blanking and variations thereof. Apparatus include power control apparatus, radar estimator devices and systems comprising these devices. The systems, apparatus and methods disclosed herein can be used alone or in combination to provide the advantages discussed herein. The embodiments need not be implemented in combination. Rather, each will find applicability independently of the others in various environments and implementations. Each of the disclosed and described embodiments solves interference problems to achieve advanced next generation network implementations that can operate simultaneously with interfering devices such as high power, narrowband radar systems.

For example, embodiments allow advanced next generation networks and devices such as 5G networks and devices to co-exist with airborne radar equipment operating in environments and with characteristics such as those described in NTIA specification TR-99-360 incorporated herein by reference in the entirety. It should be noted however, the systems, apparatus and methods disclosed and described herein are not limited to any particular 5G network implementations or devices, nor are they limited to application with particular types or classes of interferers. Rather, in addition to finding applicability in the context of the particular example interferers discussed herein, the disclosed systems, apparatus and methods can be used with many other kinds of interferers, both narrow band and wide band, and will find a wide variety of practical applications in which they solve a wide variety of coexistence problems.

One exemplary practical application accommodates radar interferers. Radars have very sensitive receivers and use very high gain antennas and are vulnerable to interference from 5G transmitters. This is the case even though devices implementing 5G technology transmit at low power compared to radar transmission power. Even these low power transmissions could interfere with critical radar operations. The 5G devices are likewise vulnerable to interference from radar transmitters. Radars can transmit high power, such as 90 dBm and are equipped with high gain antennas (such as 40 dBi gain), effectively resulting in high powered interference to 5G systems and devices.

Thus there is a further need for networks, systems, apparatus and methods including architectures, algorithms, and procedures by which devices and systems comprising advanced wireless networks such as 5G wireless systems, can coexist with particular kinds of interferers such as high powered radars and other similar interferers, even where the practical environment does not meet the ideal in which licensed and dedicated spectrum are available and there are no challengers like radar equipment operating within the same portions of the spectrum. The embodiments disclosed and described herein are suitable for implementation to maximize spectrum efficiency to allow more devices to operate in a limited spectrum, even in high SNR regions and highly congested and contested spectral environments. At the same time, the systems, methods and apparatus provide solutions to problems that arise and must be solved to achieve coexistence with interfering devices such as airborne radar.

FIG. 1E shows example interference levels at an example 5G receiver from a radar transmitting at 90 dBm from 10 Km height and operating with 40 dBi antenna when the radar beam is directed at the gNB. FIG. 1F illustrate the interference caused by 5G gNB to radar receivers for the case where the 5G gNB are transmitting at 38 dBm EIRP and 5G beams are directed at radar. The black dashed line indicates an exemplary interference threshold that is tolerable to the radar. Note that the interference levels are significantly higher than the threshold.

To address this kind of problem, some embodiments provide a radar estimator device. A radar estimator device can be implemented in one or more nodes of a network. Alternatively, a radar estimator device can be implemented outside a network environment, and one or more nodes within a network configured to cooperate with the radar estimator device to receive data therefrom. For example, in some embodiments, the radar estimator device is configured to estimate or measure, or otherwise determine one or more radar parameters, including, for example, Radar Antenna Rotation Timing, Radar Pulse Timing, Radar pathloss, Radar Received PSD at a 5G cell, Radar AoA, ToA and coordinates, number or list of cells in radar main beam, and GPS timestamp. The radar estimator device can report or transmit one or more of the parameters to a node, management component or other component or system comprising a 5G network.

FIG. 2 is a high-level block diagram of a system implementation according to embodiments. System 200 comprises a set 250 including a plurality of cells 240 (three shown, one indicated at 240). Each cell 240 includes a node (gNB) (three shown, one indicated at 220). A plurality of UE 231-233 operate in each of the cells 240. A plurality of radar estimator devices 205, 210 provide parameter values as discussed in detail below.

An example interferer is an Airborne Warning and Control System (AWACS) radar 270, which operates within range of set 250 to cause interference 271. In this case, Airborne radar (as defined in Table 6 of Technical Characteristics of Representative 3.1-3.7 GHz Government Radars of NTIA specification TR-99-360, incorporated herein in its entirety by reference, operates anywhere the 3.1 to 3.7 GHz band. In embodiments in which an advanced network such as a 5G network operates in n78 band 3.3 to 3.8 GHz band, both in-band interference and adjacent band interference can be experienced.

FIG. 3 is a block diagram showing in-band radar interference 372 with respect to the 5G band 374 according to embodiments.

FIG. 4 is a block diagram showing adjacent band radar interference 378 with respect to the 5G band 376 according to embodiments.

FIG. 5 further illustrates a system according to embodiments including a radar estimator system component 504, in the context of a 5G implementation comprising a 5G Core Network 522+5G gNB ((CU+DU) 524+RU 516) and a plurality of UE 520. The Radar estimator system 504 continuously monitors the band of interest including the 5G band and the adjacent bands that cover radar operation for and detects the presence of radar, which can be an airborne radar 570 and reports the radar parameters to the 5G network. The radar sensor estimator 504 may be integrated into the RU 518, be consisted with the RU and share baseband HW, or be a fully separate physical entity. The radar estimator 504 can cooperate with an Angle of Arrival (AOA) estimator 502 to provide parameter values discussed in detail below. Node 524 is configured to cooperate with radar estimator 504 to receive parameters and information from the radar estimator. In some embodiments radar estimator 504 is configured to transmit at regular or scheduled periodic intervals. In other embodiments radar estimator 504 is configured to detect events in the environment such as sensed parameters in excess of thresholds, and to trigger a transmission in response to such events.

In some embodiments radar estimator 504 is configured to provide values for the parameters described below. In some embodiments the values are conveyed in messages, frames or other transport arrangements including fields corresponding to the parameters. Example parameters provided by a radar estimator apparatus and corresponding fields, according to embodiments, include at least one of the following.

### Radar Antenna Rotation Timing Estimates

One type of radar transmits a train of pulses using a rotating radome and high gain antenna to cover 360 degrees of monitoring with a high gain antenna. Thus, the interference at a gNB follows a pattern of relatively short duration high interference followed by longer duration reduced interference due to the rotating antenna and radome. The antenna rotation is typically periodic, rotating at a nearly fixed rate for long periods of time. The approximate rate of rotation is often known. Based on coherent detection techniques such as matched filter or non-coherent detection techniques such as power envelope detection, temporal estimates of the rotation pattern of interference are estimated and communicated to the 5G system (CN, gNB, CU, DU or RU), e.g. time and value of next interference peak, time between peaks, 30, 20, 10 dB peak width (duration of interference >−10 dBp, −20 dBp, −30 dBp). In embodiments, these patterns are used by the 5G transmitter to reduce the transmission of RF power such that interference to radar is minimized when the radar antenna is facing the 5G gNB.

### Radar Pulse Timing Estimate

Pulse doppler radars transmit a train of pulses. Following similar detection techniques outlined above, the pulse timing or Pulse Repetition Frequency PRF and pulse width are estimated by the radar estimator and reported to the 5G system (CN, gNB, CU, DU or RU). 5G systems use this information for power control and additional signal processing techniques to overcome radar interference. Multiple PRFs are often used to disambiguate radar returns and different radar modes will use different PRFs and pulse widths. Multiple pulse trains with different PRFs and pulse widths need to be tracked. Example data exchanged by the radar estimator with the 5G system include, for each detected pulse train, PRF, pulse width, pulse start time and pulse end time.

### Radar Path-Loss Estimate

Path-loss estimates require prior knowledge of the radar transmit power. The difference between the total received power evaluated in the radar bandwidth at the Radar Estimator and the transmitted power, which is known before-hand, is used for path loss estimates. Alternatively, in cases when radar Tx power is not known, multiple radar estimators can coordinate to geo-locate the radar using time difference of arrival or other geo-location algorithms to determine the distance between the radar transmitter and the radar estimator. The pathloss is then estimated using various pathloss models, one such being the free space path loss model. The pathloss estimates are useful to evaluate the aggregate interference caused by 5G systems at the radar receiver based on the transmit power of 5G in the radar interference band and adjacent bands.

### Radar Received Power Spectral Density (PSD) at 5G Cell

The radar estimator performs spectral analysis within the bandwidth of interest and provides a power spectral density estimate or transmit mask estimate or an adjacent channel leakage ratio estimate (ACLR) of the interference source. The PSD estimate is then used to evaluate the radar carrier frequency and the bandwidth by comparing the normalized PSD with predefined thresholds. The estimates of carrier frequency and radar bandwidth are useful to identify 5G time-frequency resources that can be subjected to reduced transmit power to limit 5G system interference to radar.

### Radar AoA, ToA and Coordinates Estimate

Using AoA estimators or by using the I/Q samples in the band of the interference (radar), AoA of the interference can be estimated by using well known signal processing algorithms such as beam-scan, minimum variance distortion-less response (MVDR), or multiple signal classification (MUSIC). These angles of arrival, time of arrival are indicated to the 5G gNB. As described above, the radar estimator can use all previous estimates of the geo-location of the radar and track the location of the radar using well known prediction algorithms such as Kalman filtering to estimate the current coordinates of the interferer. With this knowledge, the 5G gNB can insert null in the direction of the direct path (free space) to mitigate the interference to the radar. Alternatively, based on the terrain information and the coordinates of the radar and the gNB receiver, ray tracing channel modeling can be used to identify the angles of arrival of the interferer at the gNB.

### Number or List of Cells in Radar Main Beam

To evaluate the aggregate interference to a radar caused by a 5G system (including 5G cell Tx and UE Tx), an estimate of the number or list of gNBs in the main beam of the radar is computed by coordinating radar sensors. A central entity collects reports from multiple radar estimators to count and list the 5G gNBs that are in the look of radar main beam. To meet the radar interference tolerance threshold, the 5G gNBs and their UEs can scale back the transmitted power in the radar interference band such that the aggregate interference (including 5G cell and UE transmitted power) at the radar is below the interference to noise ratio (INR) thresholds of the radar. The number and Tx activity level of the UEs in each of the listed cells is also shared to the central entity so that UE contribution to the interference to radar can be accounted for in the calculation of reduced Tx power at each cell.

### GPS Timestamp

GPS timestamp is sent by the radar estimator to establish a common reference for the time value information elements communicated to the 5G gNB.

In some embodiments at least one of the following mitigation methods and techniques are performed to limit interference from and to the radar system.

FIG. 6 illustrates an example of PRB blanking. Time-Frequency Radio resources (PRBs) experiencing radar interference or resources that may cause interference to radar are excluded from cell wide UL and DL usage by the 5G system. In some embodiments UE specific PRB blanking is performed, i.e., PRB blanking is implemented per UE instead of cell wide resource allocation exclusion. Traffic shaping or lowering MCS to the extent permitted by QoS class to limit 5G RF PSD.

In some embodiments a resource scheduler implements resource scheduling methods to provide enhanced PRB blanking. One approach to reduce interference to the radar interferer is to dynamically configure the network by scheduling that avoids using the same time-frequency resources as the radar when the radar is actively transmitting or listening for the return pulses. This PRB Blanking approach can be applied cell-wide, and can include cell specific PRB blanking. For example, estimates of radar rotation timing estimates and power spectral density can be determined and provided by the radar estimator as discussed above. The time-frequency interference region can be evaluated. A scheduler component, e.g., a 5G scheduler is configured to avoid allocating any corresponding resource blocks for uplink or downlink traffic. For example, certain time-frequency resources can be excluded from allocations. Examples are identified in FIG. 6 by the RBs 620 defined in time from ExclusionStartTime 610 to ExclusionEndTime 614 and defined in frequency from ExclusionFreqStart 612 to ExclusionFreqEnd 616.

In embodiments, the blanking is complete where all 5G channels are not allowed to use the excluded time-frequency resources. In further embodiments the blanking is partial where 5G control channels such as SSB, CSI-RS, and PDCCH are allowed to use the restricted PRBs 620 while the 5G data channels are not scheduled to use the excluded time-frequency resources.

In some embodiments additional actions are performed to enhance the PRB blanking procedure. For example, rather than a binary decision of avoiding or using the time-frequency resources (e.g., PRB) experiencing radar interference or resources that may cause interference to radar when the radar is listening, a max per RB power is assigned to the RBs in response to the estimated interference to the radar. E.g., RBs in the radar BW may be blanked (max Tx power=0), but RBs outside of the radar BW have max Tx power>0 and max Tx power may increase with increasing frequency separation.

FIG. 7 illustrates an alternative technique, according to embodiments. In general the exclusion/limitation RBs are defined in time from ExclusionStartTime 7100 to ExclusionEndTime 714 and defined in frequency from ExclusionFreqStart 712 to ExclusionFreqEnd 716.

Rather than cell specific blanking or Tx power limits common to all UEs in UL and DL as in FIG. 6, the blanking or max Tx power limits are UE specific and UL/DL specific as illustrated in FIG. 7. These embodiments differentiate transmissions to/from UEs that cause different amounts of interference. E.g., if UE-Radar pathloss is high but gNB-Radar pathloss is low, then UE is given a higher max Tx power limit in the same RBs that the gNB is given a lower (or zero) max Tx power limit. So, this UE (UE #X as shown) would preferentially get scheduled for UL in those RBs 740 leaving other RBs 742 available to different UEs (e.g. US #Y) that low or zero Tx limits in these RBs. The remaining excluded PRB's 750 are not used during the time frames shown.

In an embodiment, this process is described by the flow chart of FIG. 10. At step 1010 a gNB estimates radar interference for a set of PRBs and time slots based on received information from a radar estimator. At step 1012 the gNB assigns a high Tx power limit to a first UE (UE1), which has a higher UE-Radar path loss than gNB-Radar pathloss plus a first configurable margin (gNB-RadarPL+Margin_High) for a first set of RBs. At step 1013, the gNB assigns a low Tx power limit to a second UE (UE2) having lower UE-Radar path loss than gNB-Radar pathloss plus a second configurable margin (gNB-RadarPL+Margin_Low) a in a second set of RBs

Some embodiments provide dynamic network reconfiguration, including for example, reactive sector management techniques wherein sectors experiencing high radar interference or which may cause interference to radar above the INR threshold are turned off and on dynamically based on radar rotation estimates to reduce interference to and from the radar.

Some embodiments account for ACLR in the calculations. In cases in which transmission to/from a UE is in a different set of RBs than a radar, the adjacent channel leakage of the transmission is added to the adjacent RBs when considering the power limits on the RBs. In case a UE has no max Tx power limit in a granted RB, a scheduler is configured to account for the power that the UE will leak into adjacent RBs to ensure that the leaked power does not exceed the max Tx power limits in any RB. In some embodiments, actions of setting max Tx power consider ACLR since multiple UEs or DL allocations can contribute to power in unused RBs.

Aside from setting max power per RB, in some embodiments the peak power is limited across frequency-time domains (e.g., maximize the minimum (Prbmax−Prb) where Prbmax is the max permitted power in this RB and Prb is the actual) by lowering the transmitter power and MCS thus forcing the use of more spectrum and more time slots to be used to send the same number of information bits. This lowers the PSD at any given time, but also lowers the overall energy per bit and thus lowering the over RF footprint for the network.

In some embodiments, a scheduler is configured with an objective to minimize peak PSD (with respect to a ceiling) with the constraint of satisfying (but not exceeding) QoS requirements. For example, a bursty traffic is implicitly smoothed by lowering MCS or is explicitly smoothed by traffic shaping, e.g., token-bucket, to the extent permitted by the QoS class.

When the lowering of MSC and power lowers capacity or worsens latency to be below that demanded by the QoS, then lower priority services are throttled in some implementations, e.g., by dropping some bitstreams from lower priority scalable video (SCV) sessions.

Embodiments of a method include actions of introducing nulls in the most significant directions of radar signal's angles of arrival. In some of these embodiments, nulling to reduce interference to radar is performed and the effect of nulling is incorporated into estimates of interference caused to radar. For example, where a Tx null at a gNB is configured to reduce interference to radar by K dB, then the max Tx limit for a given RB is applied to the power radiated in the approximate direction of the null so that the effective max Tx power limit is increased by K dB.

FIGS. 8A-8C illustrate a beam nulling technique. 5G systems employ beamforming to increase the system performance. However, embodiments can employ beam nulling or beamforming to create one or more nulls in the strongest direction(S) of an interferer. For example, based on angles of arrival of the interference, beamforming actions are taken to create nulls in the transmitter and receiver beam forming array patterns to mitigate the interference. In some embodiments these angles of arrival, time of arrival are indicated to a node, e.g., a 5G gNB, to implement null creation. In some embodiments, a gNB performs both receive and transmit beamforming with null creation in the directions of radar to mitigate interference. FIG. 8A shows an antenna pattern for a receiver with no beam nulling. FIG. 8B shows an antenna pattern for the same receiver with nulling at 21 degrees (lobe between 30 and zero degrees is missing). FIG. 8C shows an antenna pattern for the same receiver with beam nulling at 60 degrees (lobe at 60 degrees is missing).

Systems and methods according to embodiments include some or all of the following:

In embodiments represented, for example, by FIG. 11. At step 1110, obtain or receive radar estimator data. In some embodiments, analyze data or test for presence of radar. In case radar presence is detected, perform DoA estimation during estimated pulse time.

If the radar pulse is during UL, as per step 1112, copy samples for DoA estimate and continue to process UE UL data in parallel. In embodiments. the method can include blanking the UE in UL to create a quiet period for listening to the radar.

If, as shown in step 1114, the radar pulse is during DL, create a transmit-free time gap at the gNB so that the gNB can listen to the radar.

At step 1116, project a gNB precoder onto null space of the dominant DoA in Tx and Rx for the next K TTIs, wherein K is determined by a rate of change of the DoAs. I.e., if the radar DoA is sufficiently slow, then DoA estimation frequency can be reduced to leave more radio resource available for 5G.

As shown at step 1118, after K TTIs, re-estimate the DoAs.

In some embodiments a method reactively or dynamically manages sectors. Embodiments include actions of modifying or ensuring site deployment such that all, or sufficient, or most regions have reasonable coverage by more than one sector. i.e., optimize a dense deployment for multiple coverage. Reactive sector management can mitigate the effect of both gNB and UEs transmissions on radar. In embodiments, reassigning the UE to a sector that is not being turned off is performed to avoid call drop. The offload sector can be on the same frequency carrier (intra-frequency HO with overlapping coverage with the original sector) or on a different frequency carrier (inter-frequency HO).

One or more of the following actions can be performed:

As shown in FIG. 12: at step 1210, the radar estimator data is received, including pulse timing. At step 1212 radar estimator dominant DoA-power data is obtained by the gNB; At decision point 1214, if the radar power is greater than a predetermined threshold, which in embodiments is a reactive sector triggering threshold. At step 1216 use DoA to decide which sectors to turn off (or reduce power), then at step 1220 reassign UEs based on SINR, e.g., UEs will hand-off (HO) to new best cell. If at decision point 1214, radar power is not greater than the predetermined threshold then at step 1218, turn “OFF” sectors back “ON” and reassign UEs based on SINR.

In some embodiments machine learning is applied to learn rotation timing, otherwise rations timing information is acquired to predict HO events. The predicted HO timing and target cell knowledge is then used to force UE HO proactively and thus react quicker and use fewer measurements and reports.

Some embodiments provide enhanced scheduling for UL/DL power control. User data can be used to modify a scheduler to target desired minimum throughput and minimum PSD: E.g., Prioritize UEs below target throughput. Do not schedule UEs>target+delta Use all available RBs with lowest possible MCS and Tx power that satisfies target throughput.

Some embodiments include broadcasting, e.g., using lowest power/PSD configuration for broadcast channels. Some embodiments include a precoder designed to minimize power in the marginal distribution of DoA-power over all radar positions. Some methods include actions to measure network performance both with radar ON and with radar OFF. Various metrics will be suitable to the task of meeting a target TP rather than full buffer. Other embodiments measure 5G signal strength at a radar location both with mitigation ON and with mitigation OFF.

Some embodiments include actions of Pulse Time Silencing and include obtaining or generating by a radar estimator, pulse patter and rotation pattern data. Actions can include predicting radar pulse above threshold and avoiding grants to UE that will cause interference at radar. Other actions include Blanking all gNB transmissions that will cause interference at radar.

Embodiments of methods include actions of measuring network performance with radar ON and OFF, and/or Measuring 5G signal strength at radar location with mitigation ON and OFF.

AMC techniques for reducing interference to coexisting systems such as radar are provided. 5G NR supports a very flexible adaptive modulation and code (AMC) scheme. The aim of AMC is to match the spectral efficiency of the transmission to the channel capacity for the given set of allocated radio resources. Rapid retransmission using hybrid ARQ (HARQ) permits AMC to operate at near capacity with only small latency penalty and provides robustness to bursty interference.

These (and other) mechanisms can reduce interference to airborne radar and improve low probability of intercept/low probability of detection (LPI/LPD) performance. For example, embodiments include allocating a plurality of radio resources (RBs) for a packet to spread the power over frequency and time. In some embodiments a lowest possible code rate and modulation order are used, and/or multiple repetitions of a packet is used and re-transmissions are leveraged using HARQ. With these actions, gNB power is set to minimum required, or optimal to receive such a transmission while meeting the throughput and BLER goals.

In some implementations, precoders are configured to minimize power in the marginal distribution of DoA power over all radar positions. Pulse timing silencing where based on predicted radar pulse timing, UE grants are scheduled such that certain set of symbols that coincide with estimated radar pulse timing are avoided from allocation.

An MCS is chosen to minimize interference to the airborne radar, e.g., by choosing the lowest possible SNR required for the lowest MCS that can achieve the required throughput. Actions of controlling the transmit power of 5G cells or node transmitters such that an estimated aggregate interference from all 5G cells (or transmitters) in the main beam of the radar is below the acceptable INR threshold of radar operation.

FIG. 9 illustrates throughput versus SINR curve for a fixed value of modulation and coding setting. Only a subset: mcs #0 (908), #8 (906), #16(904) and #24 (902) of the modulation and coding setting are shown for ease of explanation. In practice, any of the 3gpp 5G standards-compliant MCS values are suitable for implementing embodiments of the algorithm. To achieve a desired throughput, various SNR values and various modulation and code settings can be adjusted.

For example, in FIG. 9, for the required throughput (TP) of 100 Mbps, curve 902a to 902b for SINR dB>20 dB and curve 904a to 904b for 14 dB<SINR dB<20 dB can be used. The advantage of using higher modulation is that for a given required throughput, fewer air-interface resource blocks are needed. Commercial systems follow curve 902a to 904a to 904b to 906a to 908a to maximize spectral efficiency. However, one example embodiment aims to minimize interference to the airborne radar by choosing the lowest possible SNR required for the lowest MCS that can achieve the required throughput. Thus, in this example, an operating point is maintained in the vicinity of point 904c and a reduced transmit power lower MCS is used as well as more radio resources.

Some embodiments provide enhanced adaptive power control. In those embodiments, Tx radiation patterns are accounted for in calculation of estimated aggregate NR interference to a radar. It can be assumed that gNB do not exchange Tx radiation pattern and Tx Power used. INR threshold is the radar INR tolerance threshold. Aggregate NR interference to radar must be less than the INR threshold dBm for the radar receiver to achieve rated false alarm and detection probabilities.

In some embodiments, a method accounts for a transmission (Tx) radiation pattern by calculating estimated aggregate NR interference to a radar. In some embodiments the calculation assumes that gNB do not exchange Tx radiation pattern and in those embodiments Tx Power used in the calculation. In some embodiments, aggregate NR interference to the radar is maintained to be less than the INR threshold dBm for the radar receiver to achieve the stipulated false alarm and detection probabilities.

A method for Adaptive Power Control Enhancement at or by one or more nodes, e.g., one or more gNB Tx includes performing the following algorithm.

1) If, for example, an estimated aggregate NR interference to a radar is greater than the INR threshold dBm by Y dBm, then reduce the gNB Tx Power by Y−10*log 10(N) since Y is dBm), where N is the number of gNB in the radar beam, such that the estimated aggregate NR interference to radar is less than the INR threshold dBm.

2) If the estimated aggregate NR interference to the radar is less than the INR threshold dBm, then increase the gNB Tx Power subject to available headroom while accounting for all gNB causing interference to radar.

3) Increase each UE Tx Power subject to available headroom.

In some embodiments, a radar sensor estimator provides for a plurality of gNB (N) in a radar spotbeam. Each gNB uses its Tx Power in the direction in the radar and assumes all gNB's are transmitting the same power in the direction of the radar to estimate aggregate NR interference at the radar.

In an alternative, more conservative embodiment: the assumption is made that every gNB transmits max EIRP scaled by element pattern. Note that this embodiment assumes knowledge of orientation of RUs of each gNB. If knowledge of orientation is not known, assume maximum EIRP.

Some embodiments provide a method for adaptive power control enhancement at gNB Rx, including reducing MCS rate to create power headroom, and using the power headroom to reduce UE Tx power according to the reactive sector management embodiments as described above.

A further embodiment addresses the case where a radar is interfering with a 5G NR network while the network is not interfering with the radar is detected, indicated or otherwise known.

In a first case, the following assumptions are made:

1) The radar interference to the network is assumed to be below a power headroom threshold by X dB. 2) The power headroom threshold is the Tx power level at the network such that the interference caused to the radar is tolerable. For example let gNB Rx sensitivity be −91 dBm for 20 MHz signal (G-FR1-A1-5 test signal, QPSK, ⅓). These values illustrate one example, sensitivity numbers can change based on the bandwidth used and MCS selected. 3) The INR target is 1 dB degradation. The noise floor (kTB at 30 MHz)=−99 dBm, and the target power level at radar receiver is INR threshold dBm. 4) The sum of transmit powers per gNB towards radar<Pathlosses+INR Threshold dBm. 5) All interference from each gNB is non-coherently summed at the radar. 6) All gNBs have the AoA and radar range information.

In embodiments, a decentralized approach is taken, that each gNB applies a correction factor based perceived AoA and pathloss. Only gNBs in the path of interference follow the Tx power control. The overall power is within the limits based on radar estimator inputs, such that the aggregate interference at radar is less than the INR threshold dBm.

Dense deployments may be used to allow gNBs to transmit below maximum power to provide headroom to allow gNBs to mitigate radar interference by increasing their transmit power level

In some embodiments, and based on the above assumptions, the following actions are performed:

1) the radar estimator provides a range of radar. One or more nodes, e.g., one or more gNBs impacted or vulnerable to interference determines a power headroom that can be used without interfering with the radar.

2) The one or more nodes gNBs increase the total Tx power until the point at which the radar impact is detected, predicted or indicated. This situation mostly applies when a radar appears and disappears from the horizon

3) The one or more nodes or gNBs gradually apply power ramping at the PHY layer by using X dB steps (e.g. 0.2 dB) and accumulate a power ramping error.

4) The one or more gNBs send an SI update for SS_PBCH absolute power changes at Y dB steps of power ramping error (e.g. every ±3 dB) so as to minimize sudden jumps in Path loss estimation for UEs waking up, ready to transmit packets, etc.

5) Some embodiments include actions of detecting, predicting or receiving indication that the radar is moving away or not present. In response, the one or more nodes or gNB perform the above actions in reverse to restore normal operating power levels. Some embodiments can rely on 3GPP R15 NR SI update mechanisms for UEs to sync up.

For the above-stated embodiment, the radar estimator provides estimates, wherein, a) Each gNB is provided with its corresponding AoA, radar range (pathloss and Rx power), b) the set of RUs potentially effected in the radar path, whereby the estimates can be used to limit gNB Tx power. For example, a plurality of nodes, e.g., gNB cooperate to limit the gNB transmit power.

Some embodiments address the case of a radar interfering with NR and NR interfering with radar.

In a first case, aggregate NR network interference to the radar is above the INR threshold of radar by X dB.A radar estimator provides information on path loss, Rx power (PSD), Active BW (start and end), AOA. The following assumptions are made:

1) The sum of transmit powers for all gNBs at radar receiver is less than an INR Threshold dBm.

2) BW=Radar interference Bandwidth. (For example, 99% BW)

3) In some cases, transmission over a wider BW is effected to reduce interference to the radar.

4) Some embodiments assume a node, e.g., a gNB is transmitting over a narrower BW; e.g., 20 MHz, interferes more than a gNB transmitting over wider BW; e.g., 100 MHz. The benefit may be optimal when the gNB is using smaller spectrum before the event.

5) Bandwidth parts (BWPs) can be configured in a narrow band approach, accordingly a gNB scheduler can employ small spectrum to transmit DL channels. Increasing the spectrum by using a larger BWP can be performed to achieve a beneficial result of reducing interference to radar.

In some embodiments, and based on the above assumptions, the following actions are performed:

1) Receiving or obtaining radar estimator information. Some embodiments include actions to analyze the information, or actions to detect a radar approaching the NR network.

2) At least one node, e.g., a gNB impacted by or vulnerable to interference, determines a negative power headroom that can be used without interfering with a radar.

3) The at least one gNBs decreases a total Tx power until a point at which a 10% BLER target cannot be met.

4) In some embodiments power reduction actions are applied in affected resource elements, resource blocks or bandwidth portions. In other embodiments power reduction actions are applied across the full bandwidth. Power reduction actions include at least one node, e.g., at least on gNB, gradually applying power ramping down at PHY layer by using XdB steps (e.g., 0.2 dB) and accumulating a power ramping error.

5) In some embodiments, the at least one gNB sends an SI update for SS_PBCH absolute power changes at Y dB steps of power ramping error (e.g., every ±3 dB), so as to minimize sudden jumps in path loss estimation for UEs waking up, ready to transmit packets etc.

6) Some embodiments include receiving indications, or detecting the radar is moving away or not present, and in response the above actions are performed in reverse to thereby restore normal operating power levels.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method of physical resource block (PRB) specific interference mitigation performed by a first base station, the method comprising:
estimating an interference pattern associated with a system that transmits and receives electromagnetic radiation in a frequency range shared with the first base station; and
based on the interference pattern, assigning a maximum transmission power to a first PRB.

2. The method of claim 1, wherein the system that receives electromagnetic radiation is a ground-based radar system or an airborne radar system.

3. The method of claim 1, wherein the system that receives electromagnetic radiation operates in a first frequency bandwidth, further comprising assigning a zero transmission power to PRBs in the first frequency bandwidth.

4. The method of claim 3, further comprising reducing power in PRBs that are adjacent to the PRBs in the first frequency bandwidth such that the maximum transmission power assigned to the first PRB is not exceeded due to power leaked by PRBs adjacent to the first PRB.

5. The method of claim 3, further comprising increasing transmit power limits for PRBs outside of the shared frequency range by amounts based on frequency separation of the PRBs outside of the shared frequency range.

6. The method of claim 1, further comprising: assigning a first maximum transmit power level to a first set of PRBs used by a first user equipment and assigning a second maximum transmit power level to a second set of PRBs used by a second user equipment, wherein the first maximum transmit power level is higher than the second maximum transmit power level and a pathloss of the first UE to the radar is greater than a pathloss of the second UE to the radar.

7. The method of claim 2, further comprising receiving by the base station at least one radar parameter from a radar parameter estimator and assigning the maximum transmission power to the first PRB based on the at least one radar parameter.

8. The method of claim 1, wherein a second base station operates in a reception range of the system that receives electromagnetic radiation and wherein the maximum transmission power assigned to the first PRB is based in part in on transmission power levels assigned to PRBs associated with the second base station.

9. A wireless network for operation in reception range of a system that transmits and receives electromagnetic radiation in a frequency range shared with the wireless network, comprising:
a base station and
an interference estimator, configured to estimate an interference pattern associated with the system that transmits and receives electromagnetic radiation;
wherein the base station is configured to receive the interference pattern, and assign a maximum transmission power to a first PRB.

10. The system of claim 9, wherein the system that receives electromagnetic radiation is a ground-based radar system or an airborne radar system and the interference estimator is a radar parameter estimator.

11. The system of claim 9, wherein the system that receives electromagnetic radiation operates in a first frequency bandwidth, further comprising the base station being configured to assign a zero transmission power to PRBs in the first frequency bandwidth.

12. The system of claim 11, wherein the base station is further configured to reduce power in PRBs that are adjacent to the PRBs in the first frequency bandwidth such that the maximum transmission power assigned to the first PRB is not exceeded due to power leaked by PRBs adjacent to the first PRB.

13. The system of claim 11, wherein the base station is further configured to increasing transmit power limits for PRBs outside of the shared frequency range by amounts based on frequency separation of the PRBs outside of the shared frequency range.

14. The system of claim 9, wherein the base station is further configured assign a first maximum transmit power level to a first set of PRBs used by a first user equipment (UE) and assign a second maximum transmit power level to a second set of PRBs used by a second UE, wherein the first maximum transmit power level is higher than the second maximum transmit power level and a pathloss of the first UE to the radar is greater than a pathloss of the second UE to the radar.

15. The system of claim 10, wherein the base station is further configured to receive least one radar parameter from the radar parameter estimator and to assign the maximum transmission power to the first PRB based on the at least one radar parameter.

16. The system of claim 9, further comprising a second base station that operates in a reception range of the system that transmits and receives electromagnetic radiation and wherein the base station is configured to assign a maximum transmission power to the first PRB based in part in on transmission power levels assigned to PRBs associated with the second base station.

17. A method for operating a wireless transmit/receive unit (WTRU) in a wireless network having a base station and which operates in reception range of a system that transmits and receives electromagnetic radiation in a frequency range shared with the wireless network, comprising:
receiving a maximum transmission power for a first assigned PRB from the base station, wherein the maximum transmission power is based on an interference pattern of the system that transmits and receives electromagnetic radiation.

18. The method of claim 17, wherein the system that transmits and receives radiation is a radar.

19. The method of claim 18 wherein the maximum transmission power is further based on a path loss between the WTRE and radar, and/or between the base station and radar.

20. The method of claim 19, wherein the path loss between the WTRE and radar is determined at least in part by the WTRE.
